(19) United States
(12) Patent Application Publication
(10) Pub. No.: US 2024/0261769 A1
(43) Pub. Date: Aug. 8, 2024

(54) Isolated Metal Species in Metal-Zeolite Catalytic Material for Low Temperature SCR of NOx with NH3

(71) Applicant: Paul Scherrer Institut, Villigen PSI (CH)

(72) Inventors: Dominik Wierzbicki, Nussbaumen (CH); Davide Ferri, Zürich (CH); Maarten Nachtegaal, Remigen AG (CH); Oliver Kröcher, Klingnau (CH)

(21) Appl. No.: 18/566,216

(22) PCT Filed: May 18, 2022
(86) PCT No.: PCT/EP2022/063393

§ 371 Date: Dec. 1, 2023

(30) Foreign Application Priority Data
Jun. 1, 2021 (EP) 21177194.4

(51) Int. Cl. B01J 29/46; B01D 53/94; B01J 37/02

(52) U.S. Cl. CPC B01J 29/46; B01D 53/9413; B01J 37/0203; B01J 37/0213; B01D 2255/20738; B01D 2255/504; B01D 2257/404; B01J 2229/16

(57) ABSTRACT

A synthesis method for a selective catalytic reduction (SCR) catalyst results in the fabrication of Fe/ZSM-5 catalyst with almost exclusively isolated Fe species. The process allows to get more insight into the structure and role of Fe isolated species using in-situ X-ray absorption spectroscopy. The results point to the existence of distorted square-planar Fe2+ species under reducing atmosphere, which is in good agreement with XANES simulations. At lower temperatures Fe species are partially moving out of square-planar to distorted square pyramidal geometry, which is caused by adsorption of one of the reactants. This further improves the understanding of structure-activity relationships and rational development and the application of Fe zeolites in NOx abatement.

The present invention relates to a method for preparing a metal/zeolite catalytic material for low temperature selective catalytic reduction (SCR) of nitrogen oxides (NOx) with ammonia (NH₃). Further, the present invention relates to a metal/zeolite catalytic material for low temperature selective catalytic reduction (SCR) of nitrogen oxides (NOx) with ammonia (NH₃). Furthermore, the present invention relates to a method for using a metal/zeolite catalytic material for low temperature selective catalytic reduction (SCR) of nitrogen oxides (NOx) with ammonia (NH₃).

The selective catalytic reduction of NOx by ammonia (NH₃) (NH₃—SCR) has been a major environmental catalysis topic over the last decades because of the constantly evolving and increasingly stringent worldwide emission regulations. While the first commercialized SCR technology for stationary sources involved vanadium-based catalysts, the need for higher activity at low temperature and of stability at high temperature together with the concerns on the impact of vanadium on health fostered the development of alternative catalytic systems especially for mobile applications, particularly for the treatment of the exhaust gases from gasoline engines. Cu- and Fe-based zeolites are currently the most widely studied and commercialized catalysts for NH₃—SCR.

Cu-based zeolite catalysts exhibit remarkable catalytic activity in the low temperature region (<300° C.). At high temperature, properly tailored Fe-zeolite catalysts display higher activity and especially higher N2 selectivity, which is of upmost importance in the treatment of flue gases of stationary sources because of the emissions of N₂O, a more potent greenhouse gas than CO₂ whose anthropogenic emissions exceed 900 kt/year.

Despite the large efforts made so far, there is still an impellent need to develop a catalyst that is highly active and selective in the whole temperature range. The well-defined molecular species obtained with Cu-zeolites at low temperature that are responsible for NH₃—SCR are lost above 300-350° C. and the attachment of Cu atoms to the zeolite framework endangers selectivity. These aminated species seem to be absent in Fe-based zeolites but their function is taken up by isolated monomeric Fe-species, which are considered the active Fe species in low temperature NH₃—SCR.

However, isolated species are usually accompanied, and typically overwhelmed, by various polyatomic species and oxide particles that contribute mainly to the high temperature activity. The difficulty to prepare materials with very well-defined Fe sites is a major issue in the synthesis and development of Fe-based zeolites. The presence of polyatomic species such as oligomers, oxo iron species in exchange positions, FeₓO_{y} and Fe₂O₃ particles makes the assignment of the structure of the active site also very challenging, especially when a bulk method such as X-ray absorption spectroscopy (XAS) is exploited to derive structural and mechanistic insights under reaction conditions.

In situ XANES studies initially suggested that tetrahedral (Td) Fe³⁺ species are the isolated active Fe species, while octahedral (Oh) and distorted Td Fe³⁺ sites seem preferred over Td species in recent studies. Oligomeric species, which are believed to be inactive at low temperature, tend to form at the exchange positions present in the large pores of zeolites (α position), i.e. the framework aluminum atoms. Thus, a plausible approach to avoid the formation of oligomeric species is to remove framework aluminum prior to introduction of Fe.

It is therefore the objective of the present invention to provide a method for the preparation of a catalytic material which has a high activity and NOx selectivity already at low temperature and ideally also over the complete temperature range of the desired NOx reduction. Further, it is the objective of the present invention to provide a catalytic material in this regard. Furthermore, it is the objective of the present invention to provide a method for the selective catalytic reduction of the nitrogen oxides with ammonia.

With respect to the method for the preparation of the catalytic material this objective is achieved according to the present invention by a method to prepare a metal/zeolite catalytic material for selective catalytic reduction of NOₓ comprised in an exhaust gas stream, comprising the steps of:
a) dealuminating the zeolite in an aqueous acidic solution, or using water vapour, at an elevated temperature for a predetermined amount of time;
b) preparing a metal-complexing agent complex and stabilizing the metal-complexing agent complex at a predetermined pH in an aqueous solution;
c) mixing the dealuminated zeolite with a solution comprising the stabilized metal-complexing agent complex; and
d) drying the metal-complexing agent complex replaced zeolite and calcining the metal-complexing agent complex incorporated zeolite at elevated temperature for a predetermined amount of time for achieving the metal/zeolite catalytic material.

Thus, the method allows to obtain a catalytic material with an unprecedented high content of isolated metal species and as a consequence enhanced low temperature NH₃—SCR activity. This catalytic material enables to reach high turnover frequencies (TOF). The lack of oligomeric species is reflected by the large extent of changes in the time-resolved operando fluorescence XANES spectra at the metal K-edge thus confirming the involvement of all isolated metal atoms in the redox cycle and the role of isolated metal species in low temperature NH₃—SCR.

Advantageously, the zeolite can be a ZSM-5 zeolite and the metal can be iron (Fe) and/or copper (Cu) and/or chromium (Cr), preferably iron (Fe).

In order to allow the introduction of the metal-complexing agent complex, the dealumination of the zeolite can be executed in an aqueous solution of HNO₃, resulting in increase in pore size. Preferably, in the dealumination step NH₄-ZSM-5 can be used. Further, for the preparation of the metal-complexing agent complex a solution, preferably an aqueous solution, of the complexing agent and a metal salt, preferably a metal chloride, can be used. Here, the metal salt and the complexing agent, such as EDTA, can be added in stoichiometric amounts, or the complexing agent may be used in excess.

In a further preferred embodiment of the present invention, as complexing agent one or a mixture of two or more of the following complexing agents can be used:
ethylenediaminetetraacetic acid (EDTA), nitrilotriacetic acid (NTA), diethylentriaminpentaacetic acid (DTPA), cyclohexanediaminetetraacetic acid (CDTA) and hydroxybenzyl ethylenediamine (HBED).

In order to stabilize the formed metal-EDTA complex, the metal-EDTA complex can be stabilized by adjusting the pH of the aqueous solution by the addition of a base solution.

With respect to the catalytic material this objective is achieved according to the present invention by a metal/zeolite catalytic material for selective catalytic reduction of NOₓ comprised in an exhaust gas stream wherein at least 80% of the remaining exchange sites of the metal/zeolite catalytic material are reacted with a metal-EDTA complex thereby providing isolated metal species to the zeolite, said metal/zeolite catalytic material being prepared according to the method as explained above. Excellent results in NOx conversion can advantageously be achieved when the zeolite is ZSM-5 and the metal is iron (Fe).

With respect to the process for the selective catalytic reduction of NOx comprised in an exhaust gas stream this objective is achieved according to the present invention by a process for the selective catalytic reduction of NOx contained in an exhaust gas stream, comprising the step of bringing the exhaust gas into contact with a metal zeolite catalytic material prepared according to any of the preceding claims at elevated temperature in range from 50 to 400° C. at an GHSV above 100,000 h⁻¹. The metal/zeolite catalytic material enables these high GHSVs due to the excellent selectivity and activity of the catalytic material towards the NOx content in the exhaust gas stream that is achievable by the high portion of single metal species hosted in the pores of the dealuminated zeolite.

Further preferred embodiments of the present invention are given in the remaining dependent claims.

Preferred embodiments of the present invention are hereinafter described in more detail with reference to the attached drawings which depict in:

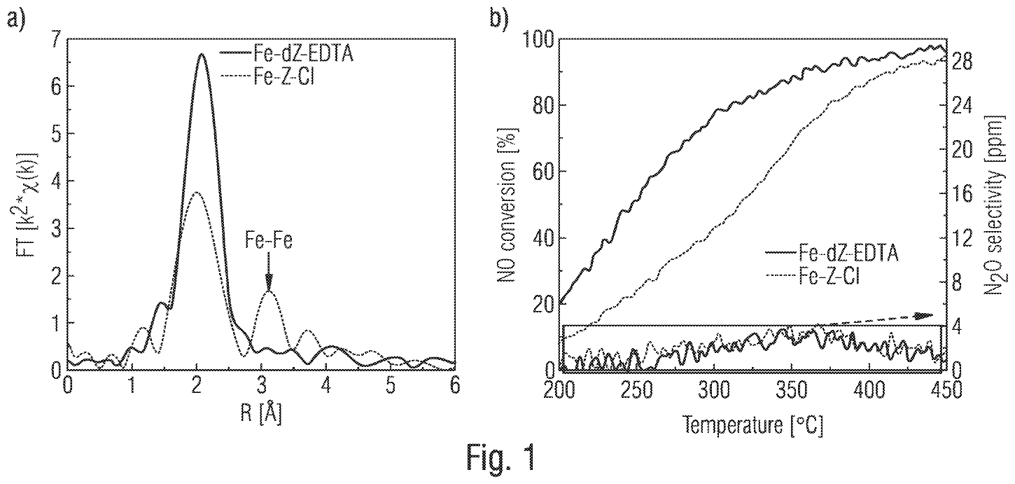

FIG. 1 (a) FT-EXAFS spectra of calcined catalysts and (b) NO conversion in NH₃—SCR;

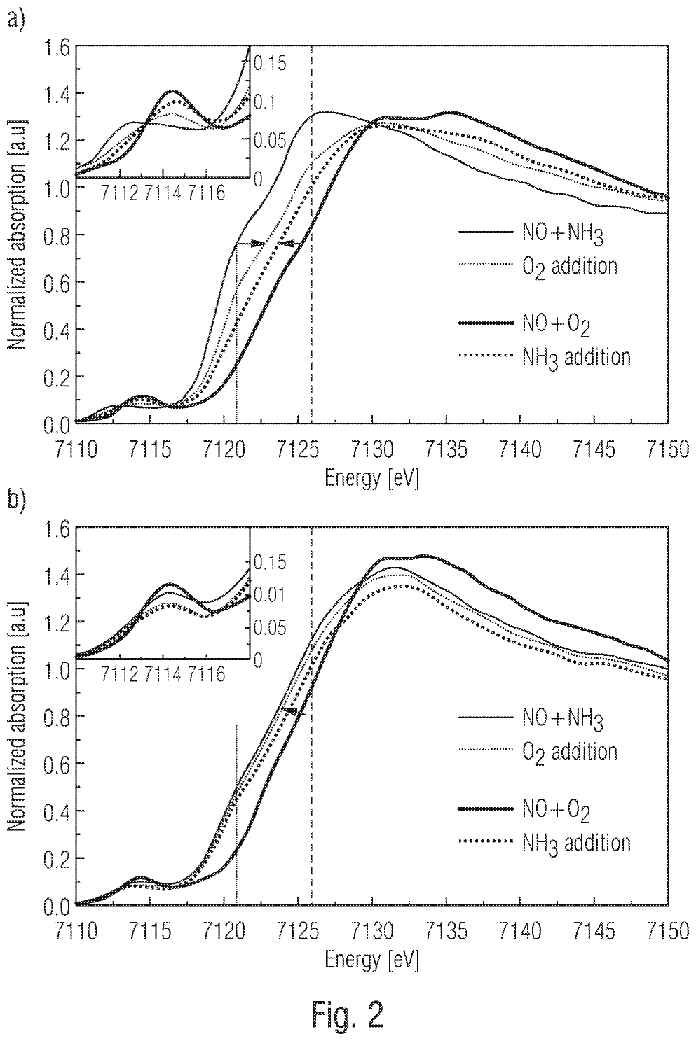

FIG. 2 Operando fluorescence XANES spectra of (a) Fe-dZ-EDTA and (b) Fe—Z—Cl obtained under NO+O₂ (solid red) or NO+NH₃ (solid black), followed by NH₃ addition (dotted red) or O₂ (dotted black) at 250° C.;

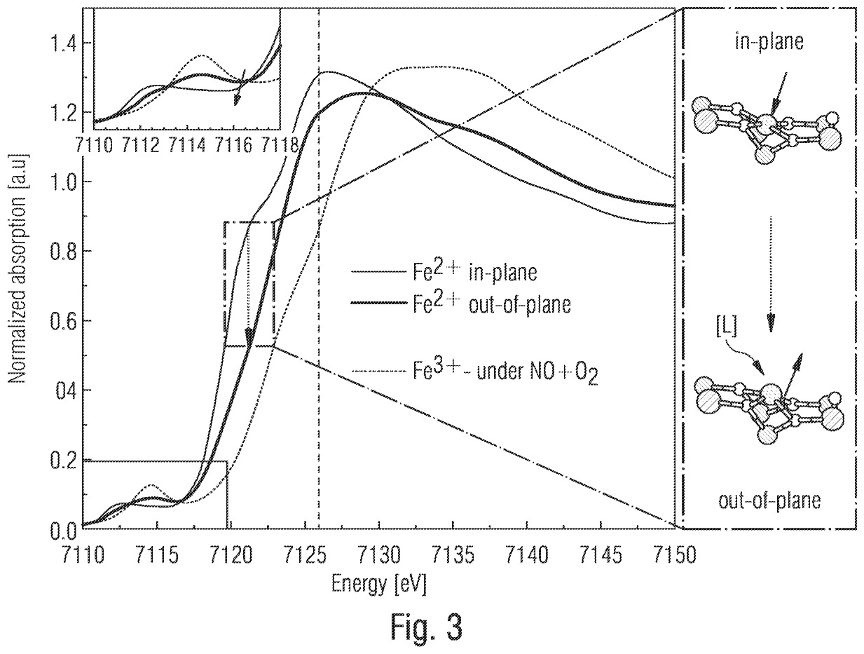

FIG. 3 XANES spectra of the three principal components needed to describe the behaviour of Fe-dZ-EDTA and Fe—Z—Cl and representation of the behaviour of the single Fe atom in a monomer moving in- and out-of-plane;

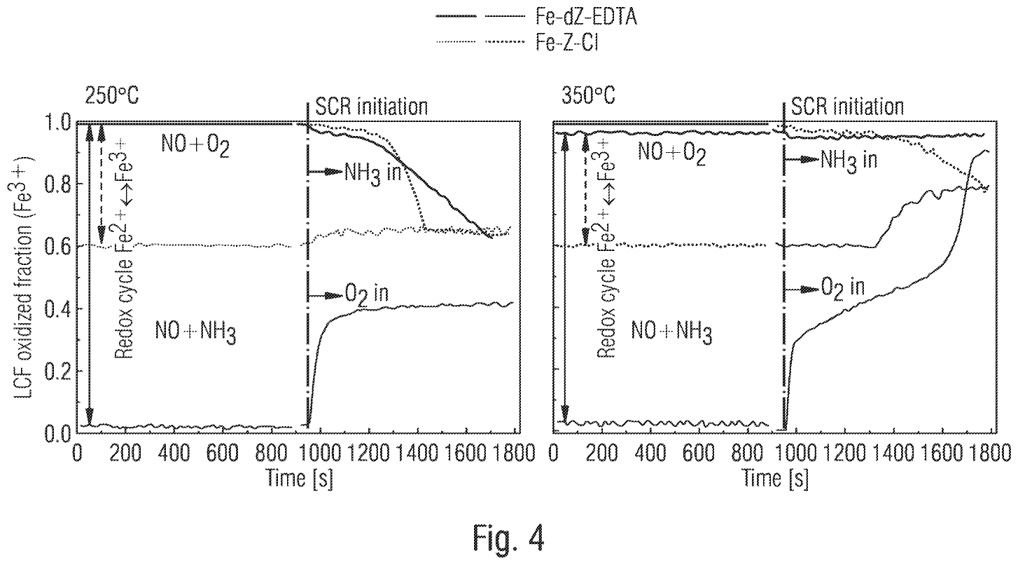

FIG. 4 LCF analysis of operando fluorescence XANES spectra of Fe-dZ-EDTA and Fe—Z—Cl recorded during O₂ and NH₃ addition experiments at (a) 250° C. and (b) 350° C.;

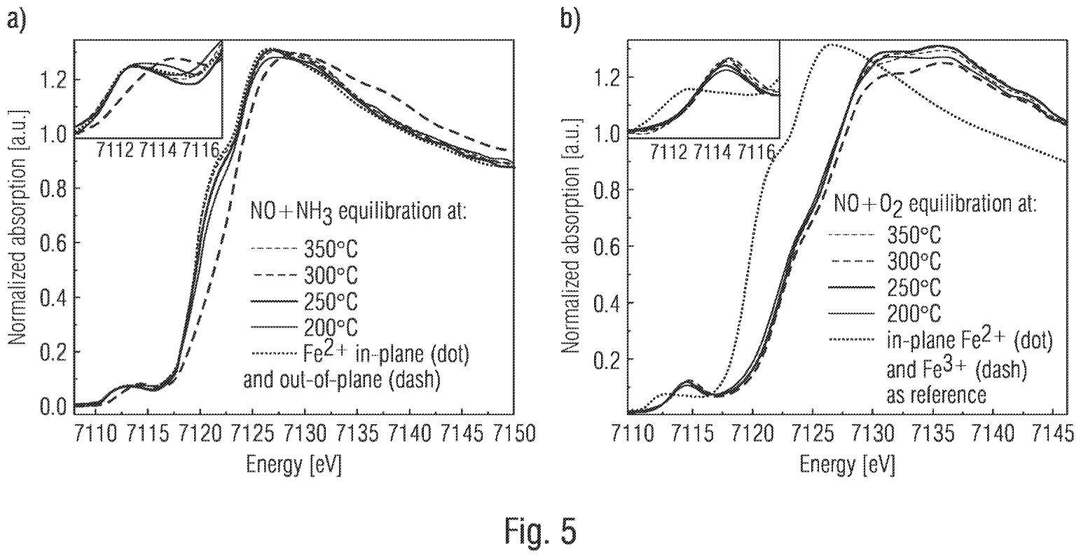

FIG. 5 Normalized operando fluorescence XANES spectra of Fe-dZ-EDTA at 200, 250, 300 and 350° C. under (a) NO+NH3 and (b) NO+O₂ feeds;

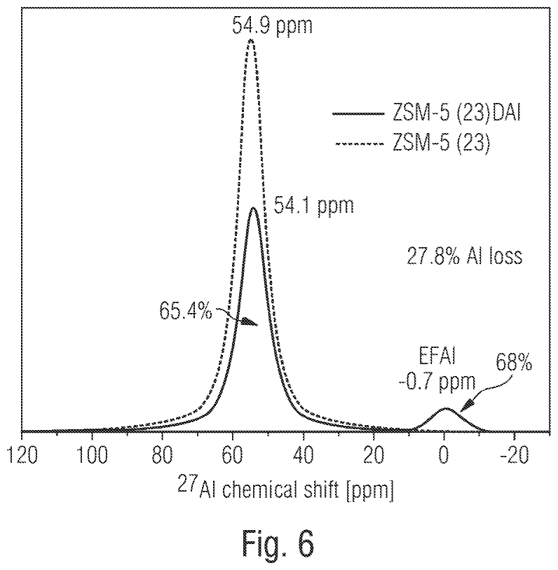

FIG. 6 ²⁷Al MAS NMR spectra of raw and dealuminated ZSM-5 materials;

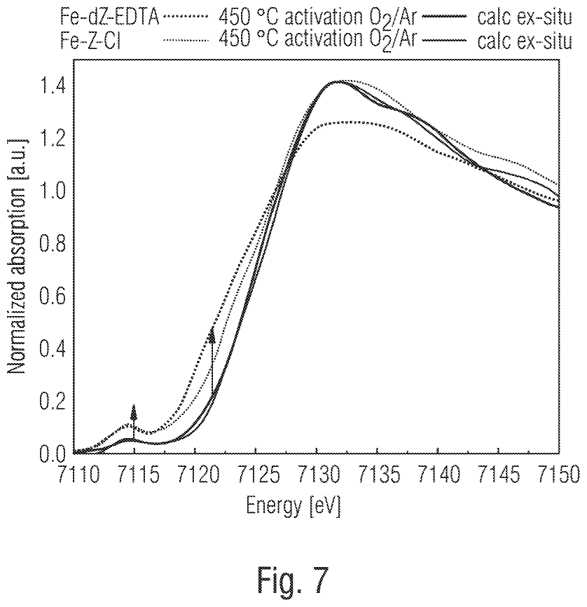

FIG. 7 Operando fluorescence XANES spectra of the initial state of Fe-dZ-EDTA and Fe—Z—Cl prior to activation and after activation; and

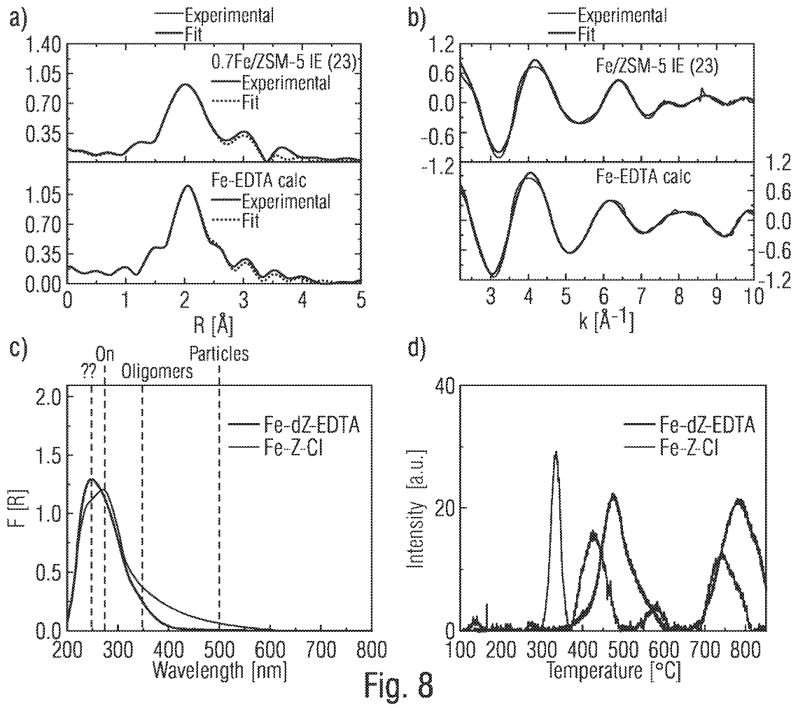

FIG. 8 (a) Best fit of EXAFS data, (b) k-space, (c) UV-Vis spectra, (d) H2-TPR experiments.

In the present invention, the partial removal of aluminum mainly from the large member rings of the zeolite is targeted, where the aluminum is more weakly bonded. Such approach decreases the probability for a metal, such as Fe, to anchor in this position, where it tends to agglomerate. Dealumination also opens pores, which allow to exploit bulky precursors to introduce metal and increase the separation of metal atoms within the zeolite.

For this purpose, a Fe-based ZSM-5 catalyst has been produced by (i) dealuminating ZSM-5, followed by (ii) adsorption of a Fe-EDTA complex into the pores of dealuminated ZSM-5, thus being able to obtain a catalyst with an unprecedented high content of isolated Fe species and as a consequence enhanced low temperature NH₃—SCR activity reaching a turnover frequency (TOF) of 79 mol_{NO}·mol_{Fe}⁻¹·s⁻¹ at 250° C. The lack of oligomeric species is reflected by the large extent of changes in the time-resolved operando fluorescence XANES spectra at the Fe K-edge thus confirming the involvement of all isolated Fe atoms in the redox cycle and the role of isolated Fe species in low temperature NH3-SCR.

Zeolite Supported Single Atom Fe Species and their Catalytic Activity

The speciation of Fe in the calcined samples obtained by dealumination of ZSM-5 and Fe-EDTA introduction (²⁷Al NMR of dealuminated and raw ZSM-5 in FIG. 6) and by ion-exchange of ZSM-5 (Fe—Z—Cl; SiO₂/Al₂O₃=23, Table 1 below) was determined especially by analysis of the corresponding extended X-ray absorption fine structure (EXAFS) spectra at the Fe K-edge of the calcined material (FIG. 1a; Table 2 below). The high intensity of the Fe—O peak (1.99-2.04 Å) and the absence of a contribution due to Fe—Fe scattering at ca. 3.00 Å, indicative of Fe—O—Fe bonds in oligomers, demonstrate that the Fe species are present predominantly as isolated species. This is confirmed by the observation that the normalized XANES spectra of Fe-dZ-EDTA (FIG. 7) lacks the contribution due to Fe—Fe scattering between the pre-edge (1 s→3 d quadrupole transition) and the absorption edge. The best fit parameters of the EXAFS spectra (FIG. 8a-b, Table 2), the UV-Vis spectra (FIG. 8c) and the temperature programmed reduction thermograms (H₂-TPR, FIG. 8d) point to two very different samples. Fe-dZ-EDTA comprises almost exclusively isolated Fe species, most likely monomers, while Fe—Z—Cl is characterized by a variety of Fe species including probably a large content of oligomers typical of ion-exchanged catalysts.

The presence of predominantly isolated Fe species obtained by our synthesis method was mirrored by a higher NO conversion in the temperature range 200-400° C. (FIG. 1b) at high gas hourly space velocity (GHSV=540 000 h⁻¹) to enhance differences. At 300° C., the difference in NO conversion between the two catalysts was the highest, reaching 75% and 40% for Fe-dZ-EDTA and Fe—Z—Cl, respectively. The lower activity of the ion-exchanged catalyst may be explained by a higher fraction of oligomeric species and particles in this sample, in agreement with the observation that oligomeric Fe species and particles are not or are less active in low temperature NH₃—SCR. The Fe-dZ-EDTA sample shows high activity in the low temperature regime reaching NO conversion of 52.1% and TOF of 79 molNO·molFe⁻¹·s⁻¹ at 250° C., while Fe—Z—Cl showed 23.8% NO conversion and reached 25 molNO·molFe⁻¹·s⁻¹ at this temperature. The slightly higher activity of Fe-dZ-EDTA above 400° C. must be related to the higher content of Fe in this sample (0.84 wt % Fe; Table 1) than in Fe—Z—Cl (0.7 wt % Fe).

### Structure of Fe Under Reaction Conditions

The behaviour of the very different Fe species in the two samples was followed with time-resolved operando XANES upon initiation of the NH₃—SCR reaction in two types of experiments at 250° C.:
(i) addition of NH₃ to the sample equilibrated in a NO+O₂ feed and (ii) addition of O₂ to the sample equilibrated in a NO+NH₃ feed. FIG. 2 shows the Operando fluorescence XANES spectra of (a) Fe-dZ-EDTA and (b) Fe—Z—Cl obtained in NO+O₂ (solid red) and NO+NH₃ (solid black), followed by NH₃ addition (dotted red) or O₂ (dotted black) at 250° C. Arrows represent the direction of spectral changes upon NH₃—SCR initiation by either NH₃ or O₂ addition. The dotted straight line on both graphs represents the intensity of the shoulder under reducing atmosphere at around 7121 eV.

The XANES spectra of Fe-dZ-EDTA underwent very pronounced changes in both sequences (see FIG. 2a). Reduction to Fe²⁺ in the NO+NH₃ feed (black spectrum) is characterized by (i) the pre-edge feature at ca. 7112.5 eV and (ii) the presence of a shoulder of the absorption edge at 7121 eV. On the other hand, equilibration in NO+O₂ feed, the most oxidizing conditions in the investigations, resulted in the almost complete oxidation of Fe to Fe³⁺, which is represented by (i) the replacement of the pre-edge feature at 7112.5 eV by that at 7114.5 eV and (ii) the significant shift of the absorption edge by 4.4 eV towards higher energy compared to the situation in the NO+NH₃ feed. The absorption edge position of the spectra obtained in the two feed conditions matches that of FeO and Fe₂O₃ references (FIG. 5). The unusual large shift of the XANES spectra of Fe-dZ-EDTA likely reflects the large fraction of the Fe atoms that is involved in the redox cycle. The changes during the same treatments were much less significant for Fe—Z—Cl (FIG. 2b), in agreement with the typical behaviour of Fe-based zeolites in XAS experiments.

In order to obtain deeper insights in the Fe speciation changes during equilibration (NO+NH₃ or NO+O₂) and reactant addition (O₂ or NH₃), the complete time-resolved dataset was analyzed by principal component analysis (PCA) coupled to multivariate curve resolution alternating least square fitting (MCR-ALS). This procedure allowed to extract spectra of the most representative Fe species present in the two catalysts, which experience changes upon abrupt perturbation of the reaction conditions from most oxidizing and most reducing feeds to NH₃—SCR. To capture spectroscopic signatures of all the Fe species that could possibly be present, the dataset for MCR-ALS was completed by the XANES spectra recorded during temperature programmed ramps (50-450° C.) in the presence of the individual reactants NH₃ or NO. PCA and MCR-ALS analysis identified three Fe components in the two catalysts, whose XANES spectra are shown in FIG. 3.

Based on the vastly different position of the absorption edge, the two spectra correspond to reduced Fe²⁺ species (red) and to oxidized Fe³⁺ species (blue). The spectrum of Fe²⁺ species is characterized by the pre-edge feature at ca. 7112.5 eV and the pronounced shoulder at 7121 eV. The spectrum of Fe³⁺ species is characterized by the pronounced pre-edge feature at ca. 7114.5 eV and the absence of the shoulder in absorption edge shifted towards higher energy. The isosbestic point clearly visible at ca. 7129.5 eV that is also present in the comparison of FeO and Fe₂O₃ reference spectra (FIG. 3) validates the change of oxidation state between these species. This point allows to associate the third component (black) to Fe²⁺ with an additional pre-edge feature at ca. 7114.5 eV and no visible shoulder at 7121 eV.

FIG. 3 shows XANES spectra of the three principal components needed to describe the behaviour of Fe-dZ-EDTA and Fe—Z—Cl and representation of the behaviour of the single Fe atom in a monomer moving in- and out-of-plane. Colour code: Fe—yellow, Al—white, Si—blue, O—red; [L] stands for a generic ligand.

The evident changes in the spectra obtained as a result of the synthetic approach and the presence of exclusively isolated Fe species in Fe-dZ-EDTA are ideally suited for structural analysis upon simulation of the XANES data, which was performed with the aid of the FDMNES software. For this purpose, an isolated Fe atom was placed in the α, β and γ sites of ZSM-5. The best fit matching the experimental data of FIG. 3 was obtained for Fe in β and γ sites, thus for Fe located in a 6-member ring. This was taken as representative for isolated Fe species coordinated to four 0 atoms and with two Al and four Si neighboring atoms. The simulated XANES spectrum of the reduced Fe²⁺ species points to the existence of Fe²⁺ atoms in square-planar geometry surrounded by four O atoms. In this structure, the shoulder of the absorption edge at ca. 7121 eV is due to the 1 s→4p transition. The comparison of the spectrum corresponding to the Fe³⁺ species (FIG. 3, blue) with those of FeO and Fe₂O₃ references (Figure S3) clearly shows that all Fe species are completely oxidized in the NO+O₂ feed. The best fit of the present XANES simulations for this spectrum takes into account an OH ligand, revealing that Fe³⁺ is in a distorted square-pyramidal geometry, in agreement with the presence of the pre-edge feature at 7114.5 eV and previous literature reports.

FIG. 4 shows the LCF analysis of operando fluorescence XANES spectra of Fe-dZ-EDTA and Fe—Z—Cl recorded during O₂ and NH₃ addition experiments at (a) 250° C. and (b) 350° C.

Comparison of the concentration levels of Fe³⁺ (FIG. 4a) under reducing (NO+NH₃) and oxidizing (NO+O2) feeds at 250° C. shows that 98% of the Fe species of the Fe-dZ-EDTA sample undergoes a redox change (Fe²⁺↔Fe³⁺), whereas this fraction is only 40% in the Fe—Z—Cl sample. Similar redox properties are found at 350° C. Therefore, almost all Fe species present in the Fe-dZ-EDTA catalyst actively participate in the NH3-SCR reaction and exhibit full redox potential at 250° C. and 350° C. On the contrary, in the ion-exchanged sample a large portion of species is permanently oxidized and is thus not likely to participate in the catalytic cycle. This is most probably the fraction of Fe atoms present as oligomeric species. Therefore, the high activity at low temperature NH3-SCR of the Fe-dZ-EDTA sample (FIG. 1b) must be ascribed to the vastly different response of Fe species in the two samples and to the maximized fraction of isolated Fe species obtained by the selected synthesis method.

Decrease in NH3-SCR Activity with Decreasing Temperature

Because FIG. 1b demonstrates an improved low temperature NH3-SCR activity of Fe-dZ-EDTA (200-400° C.), Fe K-edge fluorescence XANES spectra were recorded under reducing (NO+NH3) and oxidizing (NO+O2) conditions with decreasing temperature, i.e. 350, 300, 250 and 200° C., as this is shown in FIG. 5. The spectra recorded under the stronger reducing conditions of NO+NH3 than only NH3 demonstrate a gradual decrease of the shoulder of the absorption edge with decreasing temperature (FIG. 5a).

### CONCLUSIONS

The present invention discloses a method to prepared a Fe—ZSM-catalyst by introduction of a Fe-EDTA complex into a dealuminated ZSM-5 in which the fraction of isolated Fe species is maximized resulting in significantly higher low temperature NH₃—SCR activity compared to the standard ion-exchanged catalyst. Operando XAS revealed that all isolated Fe species are involved in the redox activity of NH₃—SCR. XANES simulations assigned a distorted square-planar geometry to the isolated Fe species under reducing conditions, which are characterized by a prominent shoulder at the rising absorption edge typical of Fe²⁺. While square-planar species were also present in the ion-exchanged catalyst, extraction of the pure XANES spectra would have been impossible without the data set obtained with the novel catalyst due to the large fraction of oligomeric species. The present invention represents a major step towards a better understanding of the structure of the active Fe sites under operational conditions and provides a clear description how to prepare better Fe-based catalysts for NH₃—SCR.

### Methods

### i) Synthesis of Fe/ZSM-5 Samples

NH₄-ZSM-5 zeolite with MFI structure (SiO₂/Al₂O₃=23; 400 m²/g; Alfa Aesar) was ion-exchanged with an aqueous solution of FeCl₂ of 0.05 M (100 ml/g_{zeolite}) at 80° C. for 24 h and under stirring in N₂ atmosphere in order to avoid oxidation of Fe²⁺ ions, which would cause precipitation of Fe³⁺ and formation of oligomers/particles. NH₄Cl was added in order to control the degree of exchange, in such amount that the molar ratio between Fe²⁺ and NH₄⁺ reached 1:0.5. This sample (Fe—Z—Cl) was then filtered, washed with distilled water, dried at 80° C. overnight and calcined in a stream of air at 500° C. (2° C./min) for 4 h.

For the intended modification with ethylenediaminetetraacetic acid (EDTA) as complexing agent, NH₄-ZSM-5 was dealuminated in an aqueous solution of HNO₃ (2 M; 100 ml/g of zeolite) at 80° C. for 24 h, this procedure being repeated three times. Then, the material was filtered, washed with distilled water (2 L) and dried at 80° ° C. overnight. The Fe-EDTA complex was prepared using aqueous solutions of EDTA and FeCl₂ in stoichiometric amounts. The solution of FeCl₂ was added dropwise to the solution of EDTA under vigorous stirring. In order to stabilize the Fe-EDTA complex, the pH was adjusted to 4 using an aqueous solution of NaOH (1 M). The XANES spectra were recorded for Fe(II)-EDTA and FeCl₂ as Fe precursor in the present synthesis methods. The freshly prepared solution of the complex was added dropwise to an aqueous suspension of the dealuminated ZSM-5 preheated to 65° C. under N₂ atmosphere. The suspension was left under vigorous stirring for 24 h, followed by filtering, washing with distilled water (only in case of Fe—Z—Cl) drying at 80° C. overnight and by calcination in a stream of air at 500° C. (2° C./min) for 4 h to obtain the Fe-dZ-EDTA sample.

### 1 ii) Catalytic Tests

The performance of the catalysts in the selective catalytic reduction of NO with NH₃ was evaluated at atmospheric pressure in a tubular quartz reactor with a K-type thermocouple inserted in the catalyst bed. Prior to the reaction the catalyst was activated in a stream of 10 vol % O₂/N₂ at 550° C. for 1 h at a heating ramp of 5° C./min. Then, the sample was exposed to the feed of 500 ppm NO, 600 ppm NH₃, 10 vol % O₂, 5 vol % H₂O and N₂ at a gas hourly space velocity (GHSV) of 540,000 h⁻¹ at 550° C. and the catalytic tests were started while cooling to 200° C. at a ramp of 5° C./min. The gas products including NH₃, NO, NO₂, N₂O and H₂O were analyzed using an online FTIR spectrometer (Antaris IGS, Thermo) equipped with at an acquisition time of 1 s/spectrum. The NO conversion (X_{NO}) was calculated using the following equation:

$${X}_{N O} = ( 1 - {NO}_{out} / {NO}_{i n} ) \times 100 \%$$

The turnover frequency (TOF, mol_{NO} mol_{Fe}⁻¹ s⁻¹) values were calculated using the following formula:

$$TO F = ( {X}_{N O} ⋆ {F}_{N O} ) / {n}_{F e}$$

where X_{NO}, F_{NO} and n_{Fe} are the NO conversion, the flow of NO (mol·s⁻¹) and the moles of Fe in the catalytic bed, respectively.
23 iii) Operando XAS

The sample (ca. 20 mg) was fixed between two quartz wool plugs (2 mm thick and 3 mm long) in a custom-made cell. Two graphite windows (thickness, 0.5 mm) on both sides of the cell were used to seal the cell and air-tighten the reaction environment. A K-type thermocouple was placed inside the catalytic bed from the inlet side of the cell. Mass flow controllers (Bronkhorst) were used to prepare the reaction mixtures with a constant flow of 100 mL·min⁻¹. The transient experiments were carried out with the aid of automated switching valves (Series 9, Parker) with an opening response time of ≤5 ms. The switching valves were installed as close to the reaction cell as possible, the distance between the middle of the catalytic bed and switching valves being approximately 60 mm. In order to ensure that there is no influence of the beam on the reaction, thus on Fe speciation (beam damage), an Al filter of 80 μmthickness was applied, thus, resulting in reduction of the beam flux by around 96%.

The operando XAS measurements were carried out in fluorescence mode using a passivated implanted planar Silicon (PIPS) detector at the SuperXAS beamline of the Swiss Light Source (SLS, Villigen AG, Switzerland). The storage ring operated at 2.4 GeV in top-up mode with a ring current of 400 mA. The polychromatic beam was collimated by a Si-coated mirror at 2.5 mrad and monochromatized by a Si (311) channel-cut monochromator, which allows data collection in a quick-scanning mode. For energy calibration a Fe foil was placed between the 2nd and the 3rd ionization chamber for absolute energy calibration. As the measurements were performed in fluorescence mode, the cell was moved away from the beam for the first 10 seconds in order to record the Fe foil for energy calibration. The quick-XAS spectra collected were averaged, background corrected and normalized using the ProXAS software. The same software was used for MCR spectra extraction from the whole dataset, and for further linear combination fit (LCF) analysis of the operando XAS data.

Prior to the cut-off and addition experiments the catalysts were activated at 450° C. for 1 h in a flow of 10 vol % O₂/Ar. All operando fluorescence XANES spectra were recorded with sub-second time resolution (0.5 s·spectrum⁻¹). Spectra were collected first during equilibration in either NO+NH₃ or NO+O₂ for 15 min at a given temperature. Static spectra were obtained by averaging 30 consecutive spectra in one data point for a total of 15 s. After equilibration, a second series of spectra was started in the same feed and after 1 min of data acquisition, SCR initiation was obtained by addition of NH₃ to the NO+O₂ feed or O₂ to the NH₃+NO feed using automated solenoid valves (Series 9, Parker).

TABLE 1
Labelling of the synthesized materials, elemental
analysis and description of preparation methods.

| Sample | Fe | S_{BET} [m²/g] | Synthesis method |
|---|---|---|---|
| ZSM-5 raw (SiO₂/ | — | 420 | — |
| Al₂O₃ = 23) | | | |
| ZSM-5 DA1 (ZSM-5 | — | 366 | dealumination in a 2M |
| Si/Al = 23 DA1) | | | solution of HNO₃ at 80° C. |
| | | | for 24 h, repeated three |
| | | | times |
| Fe-dZ-EDTA | 0.84 | 354 | Fe-introduction using an |
| | | | aqueous solution of Fe- |
| | | | EDTA |
| Fe—Z—Cl | 0.70 | 370 | ion-exchange using FeCl₂ |
| | | | solution |

TABLE 2
EXAFS fitting results for as-synthesized materials.

| Sample | Path | CN | R (Å) | σ² | ΔE [eV] |
|---|---|---|---|---|---|
| Fe-dZ-EDTA | Fe—O | 4.5 +/− 0.5 | 2.04 | 0.012 | 0.76 |
| | Fe—Fe | 0.0 +/− 0.1 | 3.04 | 0.028 | |
| Fe—Z—Cl | Fe—O | 4.0 +/− 0.7 | 1.99 | 0.013 | 1.15 |
| | Fe—Fe | 0.7 +/− 0.6 | 3.00 | 0.006 | |

1-11. (canceled)

12. A method of preparing a metal/zeolite catalytic material for selective catalytic reduction of NOₓ contained in an exhaust gas stream, the method comprising:
a) dealuminating the zeolite in an aqueous acidic solution, or using water vapor, at an elevated temperature for a predetermined amount of time;
b) preparing a metal-complexing agent complex and stabilizing the metal-complexing agent complex at a predetermined pH in an aqueous solution;
c) mixing the dealuminated zeolite with a solution containing the stabilized metal-complexing agent complex; and
d) drying the metal-complexing agent complex-replaced zeolite and calcining the metal-complexing agent complex incorporated zeolite at an elevated temperature for a predetermined amount of time for achieving the metal/zeolite catalytic material.

13. The method according to claim 12, wherein the zeolite is a ZSM-5 and the metal is at least one metal selected from the group consisting of iron (Fe), copper (Cu), platinum (Pt), and palladium (Pd).

14. The method according to claim 12, which comprises DE aluminizing the zeolite in an aqueous solution of HNO₃.

15. The method according to claim 12, which comprises using as the complexing agent one or a mixture of two or more complexing agents selected from the group consisting of: ethylenediaminetetraacetic acid (EDTA), nitrilotriacetic acid (NTA), diethylentriaminpentaacetic acid (DTPA), cyclohexanediaminetetraacetic acid (CDTA), and hydroxybenzyl ethylenediamine (HBED).

16. The method according to claim 12, which comprises using an aqueous solution of the complexing agent and a metal salt for preparing the metal-complexing agent complex.

17. The method according to claim 16, which comprises using a metal chloride as the metal salt.

18. The method according to claim 16, which comprises adding the metal salt and EDTA in stoichiometric amounts or adding EDTA in excess.

19. The method according to claim 12, which comprises stabilizing the metal-EDTA complex by adjusting the pH of the aqueous solution by way of adding NaOH solution.

20. The method according to claim 12, wherein the dealuminating step comprises using NH₄-ZSM-5.

21. A metal/zeolite catalytic material for selective catalytic reduction of NOₓ contained in an exhaust gas stream, comprising:
a metal/zeolite catalytic material produced according to claim 12;
wherein at least 80% of remaining exchange sites of the metal/zeolite catalytic material are reacted with a metal-complexing agent complex to thereby provide isolated metal species to the zeolite.

22. The metal/zeolite catalytic material according to claim 21, wherein the zeolite is ZSM-5 (Zeolite Socony Mobil-5) and the metal is iron (Fe).

23. A method for selective catalytic reduction of NOₓ contained in an exhaust gas stream, the method comprising:
providing a metal zeolite catalytic material prepared by the method according to claim 12; and
bringing the exhaust gas into contact with the metal zeolite catalytic material at an elevated temperature in a range from 50 to 400° C. and at a GHSV (gas hourly space velocity) above 100,000 per hour.
